(19) United States
(12) Patent Application Publication
(10) Pub. No.: US 2013/0140302 A1
(43) Pub. Date: Jun. 6, 2013

(54) LAUNCHER FOR MICROWAVES

(71) Applicants: William Robertson Cunningham Erskine, Aberdeen (GB); Andrew Terah Gough, Newcastle-under-Lyme (GB); Paul Raymond James Wicks, Shanklin (GB)

(72) Inventors: William Robertson Cunningham Erskine, Aberdeen (GB); Andrew Terah Gough, Newcastle-under-Lyme (GB); Paul Raymond James Wicks, Shanklin (GB)

(73) Assignee: EMS Waves Limited, Fenton, Stoke-on-Trent (GB)

(21) Appl. No.: 13/522,690

(22) PCT Filed: Jan. 18, 2011
(86) PCT No.: PCT/GB11/50074

§ 371 Date: Oct. 9, 2012

(30) Foreign Application Priority Data
Jan. 18, 2010 (GB) 1000748.2
Sep. 20, 2010 (GB) 1015702.2

(51) Int. Cl. H05B 6/78; H01P 3/12

(52) U.S. Cl. CPC H05B 6/78; H01P 3/12
USPC 219/690; 333/239

(57) ABSTRACT

A launcher for microwave radiation comprises an elongate guide part, a surround part which surrounds a length of the guide part, at least one inwardly facing baffle provided on an inner face of the surround part and extending towards the guide part; and at least one outwardly facing baffle provided on an outer face of the guide part which is spaced axially along the guide part relative to the at least one inwardly facing baffle and faces outwards towards the inner surface of the surround part. The baffle(s) together with the guide part and the surround part define a labyrinth seal which in use acts as a choke to prevent microwaves escaping by passing though the gap between the guide part and surround part, and are arranged so that in at least one position of the surround part and the guide part there is no direct mechanical path from the surround part to the guide part, the parts being free to move relative to one another in at least one direction from that position without creating a direct rigid mechanical path from the surround to the guide part.

This invention relates to a launcher for microwaves especially for launching microwaves into a container of feedstock so as to heat the feedstock. It is particularly suited to launching microwaves into a container that is non-static, which includes containers that may be vibrating or oscillating or rotating or any combination of such movements.

It is known to use microwaves as a source of heating of feedstock, which may be solids, liquids, gases, slurries, suspensions, emulsions or any one of a wide range of other feedstock types. The feedstock placed in a suitable container to restrain it, microwaves are generated using a magnetron and the microwaves are then directed from the magnetron into the container using a waveguide. The shape and position of the waveguide relative to the container determine how the microwaves are distributed within the container, and so determine how the feedstock is heated.

It is well known that launching microwaves into a container of static feedstock does not produce uniform heating of the feedstock. To ensure uniform heating the feedstock should be moved relative to the waveguide so that different portions of the feedstock are exposed to the microwaves in turn. In a domestic microwave oven, for example, the feedstock—usually a food item or beverage—can be moved by placing the container on a rotating platform. On a larger industrial scale feedstock may be placed on a belt which is moved past the microwaves so that different parts of the feedstock are exposed over time.

In industrial applications where larger quantities of feedstock are to be heated, it is also known to vibrate the container or to rotate it. The vibration or rotation agitates the feedstock, mixing it up and this ensures improved heating as the pasts of the feedstock move around relative to the microwave source and also relative to other parts of the feedstock. Without this movement the feedstock may settle and be heated unevenly as energy is reflected from the surface of the settled mass of feedstock.

Unfortunately, the action of vibrating the container also causes any waveguide secured to the container also to vibrate and this will in turn cause the microwave source to vibrate. Because microwaves sources are relatively delicate and expensive devices, the use of microwaves and vibration of a container has therefore in the past been limited to only small amplitudes and high frequencies.

It is an object of the present invention to ameliorate, at least partially, some of the difficulties with using microwave energy to heat a feedstock in a container that is being moved, in particular one which is being vibrated.

According to a first aspect the invention provides a launcher for microwave radiation comprising:

an elongate guide part having a first end for receiving microwave radiation and a second end through which the radiation may leave the guide part;
a surround part which surrounds a length of the guide part,
at least one inwardly facing baffle provided on an inner face of the surround part and extending towards the guide part; and
at least one outwardly facing baffle provided on an outer face of the guide part which is spaced axially along the guide part relative to the at least one inwardly facing baffle and faces outwards towards the inner surface of the surround part, such that the baffle(s) together with the guide part and the surround part define a labyrinth seal which in use acts as a choke to prevent microwaves from escaping the launcher by passing through the gap between the outer face of the guide part and the inner face of the surround part, and in which the launcher is so arranged that in at least one position of the surround part and the guide part there is no direct mechanical path from the surround part to the guide part, and in which the surround part and the guide part may move relative to one another in at least one direction from that position without creating a direct rigid mechanical path from the surround to the guide part.

By providing a launcher with a guide part and a surround complete with a labyrinth seal in which there is no rigid mechanical path from the surround to the guide part and so it is possible to launch microwaves from a delicate device such as a magnetron out of the launcher into a container which is vibrating without causing damage to the magnetron, whilst providing a seal to the container to prevent leakage of radiation. This is because the guide part is completely decoupled from the container, whilst the surround and seal prevent leakage of any microwaves that may otherwise escape.

The guide part may be free to move in any chosen direction relative to the surround part, at least over a limited distance without contacting the surround part or any part attached to it. The absence of the direct rigid mechanical link means that the surround part and guide part are decoupled from one another mechanically.

The launcher may be arranged such that is no mechanical connection at all between the surround part and the guide part, i.e. there is a clear air gap between any part of the guide, or part connected to it, and any part of the surround or part connected to it. Alternatively, one or more damping elements may be provided which provide a non-rigid connection between the surround and guide parts.

The surround part of the launcher may be fixed to a container which is suitable for containing a feedstock to be heated, the container including a window, the surround part being sealed to the container around the periphery of the window and the guide part being positioned so as to pass through the window or to direct microwaves leaving the second end of the guide part through the window. The guide part should be spaced from the container so that any movement of the container is not transferred to the guide part. The labyrinth seal ensures that microwaves passing through the launcher can only enter the container and cannot escape between the guide part and surround part.

Alternatively, the elongate guide part may be fixed to a container which is suitable for containing a feedstock to be heated, the container including a window, the guide part being positioned so as to pass through the window or to direct microwaves leaving the guide part through the window. The surround part should be spaced from the container so that any movement of the container is not transferred to the surround part. Again the seal ensures that microwaves entering the launcher can only pass through the guide part into the container, and cannot escape between the guide part and surround part.

The guide part may extend through the window, or may abut the window, or be located adjacent the window.

The guide part may comprise a waveguide which may be of solid wall or any other suitable proprietary construction. The skilled person will appreciate that the shape and dimensions of the waveguide should be selected according to the frequency of the microwave energy.

For instance, the guide part may be rectangular or circular in cross-section. Similarly the surround part may also be rectangular or circular in cross-section to complement the guide part.

It is especially advantageous that, when the guide part is circular in cross section, it is free to rotate through a range of angles around its axis, or more likely that the surround part can rotate freely around a fixed guide part. This would allow the surround part to be fixed to a container which rotates provided that the axis of the surround is coincident with the axis of rotation of the container. An example of this would be the passage of microwaves from the guide part into a spinning drum, or another container which oscillates clockwise and anti-clockwise about its axis or a container which both oscillates and rotates about its axis, for example a centrifuge or a vibrating centrifuge.

Of course, the guide part does not need to be of circular cross section along the whole of its length to be free to rotate.

The guide part may have electrically conductive walls and may comprise a hollow metallic cylindrical conductor. The guide part may have a solid base, sides and top. It may have a box shaped cross section.

The launcher may be used with a wide variety of sources of microwave energy may emit radiation at a frequency that lies within the ISM (Industrial, Scientific and Medical) frequency bands. In the case of microwave heating the bands spans the range 902 Mhz to 915 Mhz and 24. Ghz to 2.5 Ghz. However, the invention should not be considered to be limited to these ranges in all embodiments. For instance frequencies and wavelengths listed in Table 1 may be used:

TABLE 1

| Frequency | Wavelength |
|---|---|
| 24 to 24.5 Ghz | 12.49 mm to 12.24 mm |
| ¹² 61 to 61.5 GHz | 4.91 mm to 4.87 mm |
| 122 to 123 Ghz | 2.46 mm to 2.44 mm |
| 244 to 246 Ghz | 1.23 mm to 1.22 mm |

The guide part may be formed from electrically conductive material, or may be surrounded by an electrically conductive material. For example the guide part may be made of metal with a high conductivity such as copper, aluminium or brass.

A flexible conductive bonding strip may be provided which couples the guide part to the surround. This may comprise a braided copper rope. This provides an electromagnetic link between the parts without transferring harmful vibration.

The surround part may be secured to a container which is in turn mounted on an actuator which in use causes the container to move. The actuator may be means for causing the container to vibrate.

The container could be selected from a range of different types of container. For instance, it may comprise a bowl or trough, a retort, a moving bed conveyor, a vibratory conveyor, a torrifier, a mixer, a grinder, an eccentric grinding tube etc, a centrifuge or a vibrating centrifuge. The container may be located on or form an integral part of rolling stock (train or road vehicle) for conveying bulk material. It may in particular comprise a part of a vibratory conveyor system as described in International patent application No. PCT/GB2008/004292. In that case it may comprise the waveguide that forms the helical conveyor bed.

The vibration means may cause the container to move with a linear component up and down, linearly from side to side, in a circular motion, or a combination of any of these so that it could describe any desired motion in XYZ space. It may move the container through a maximum distance in any given direction away from a rest position of substantially 10 mm, or substantially 20 mm, or perhaps up to substantially 30 mm or perhaps greater.

The vibration means may comprise a vibratory bed on which the container is located. The vibration means may comprise one or more actuators and may more specifically comprise one or more unbalanced motors, rotation of the motor causing the apparatus to vibrate. Preferably two motors operating in phase may be provided. Other actuators may be provided as well or instead of an unbalanced motor. For example, one or more solenoids may be provided which when energised and de-energised with a drive current cause the apparatus to vibrate.

The motor may be provided with an electronic brake which stops the motor rapidly when power is withdrawn. This helps to prevent uncontrolled shaking of the container as the motor slows down to a stop. In one arrangement, the mechanical brake may be implemented by applying an impulse to the motor which is of reversed polarity to the normal motor current and which will cause the motor to stop rapidly.

Each baffle may extend in a plane substantially orthogonal to the long axis of the guide part. The baffles may be provided as a single plate with an opening through which the guide part passes. Alternatively, they may be provided in two half pieces which fit together around the guide part.

The launcher may include at least 3 inwardly facing baffles and at least 2 outwardly facing baffles. The inwardly facing and outwardly facing baffles are preferably interleaved alternately, e.g. one inward, then one outward, then one inward and so on.

The adjacent baffles may be spaced axially relative to one another at an axial spacing known to cause choking of the microwaves. Since this will vary with the microwave source used, the launcher should therefore be constructed with a spacing suitable for the frequency of the microwaves that are to be passed along the waveguide.

Absorber material may be provided within the spaces between at least one pair of adjacent inwardly facing and outwardly facing baffles to help further absorb any microwaves entering the surround part.

The surround part, and/or the baffles, may be provided with fluid passages through which cooling fluid can pass to prevent excessive heating of the launcher by microwaves entering the surround part.

The baffles may be aluminium, preferably aluminium sheet of approximately 3 mm thickness. They may be covered with an elastomeric material which is provided with grooves facing the baffles to form the fluid passages.

Other materials that are suitable for use in constructing the launcher include graphite and other metals such as copper. The copper is especially suitable for forming fluid passages as it is easy to produce a desired curving flow path from copper tubing.

One of the guide part and the surround part (or a part rigidly secured thereto) may be provided with a pointer, and the other part a target, the position of the pointer relative to the target providing an indication of the relative position of the guide part and the surround part. This provides a useful indicator that helps set the at least one position of the parts in use that ensures there is no mechanical path from the surround to the guide part.

The pointer may comprise a pin, and the target an opening within which the pin is located. The relative position, shape and dimensions of the pin and opening may be such that the distance from the pin to the edge of the opening in any chosen direction is indicative of the spacing between the guide part (or any part attached to it) and the surround part (or any part attached to it) in that same direction.

Conveniently the pin may be located in the centre of the hole when the guide part is located in the “no-path” position within the surround part. When in the centre location the relative positions of the guide part and surround part may provide the maximum amount of movement in any direction the lies in a plane orthogonal to the axis of the guide part.

According to a second aspect the invention provides in combination a launcher according to the first aspect of the invention, a source of microwaves connected to the first end of the guide part of the launcher, a container secured to the second end of the surround part of the launcher, and a vibration means which is connected to the container and which in use causes the container to vibrate relative to the source of microwaves.

The combination may include an actuator which causes the container to move in a vibratory manner. It may additionally or alternatively cause the container to rotate.

The apparatus may include a feed through which feedstock can be fed to the container.

The apparatus according to the invention can be used to heat a wide range of products. One particularly notable use proposed by the applicant is heating of industrial waste products. The invention is applicable to heating many other products, stuffs or materials.

There will now be described, by way of example only, one embodiment of the present invention with reference to and as illustrated in the accompanying drawings of which:

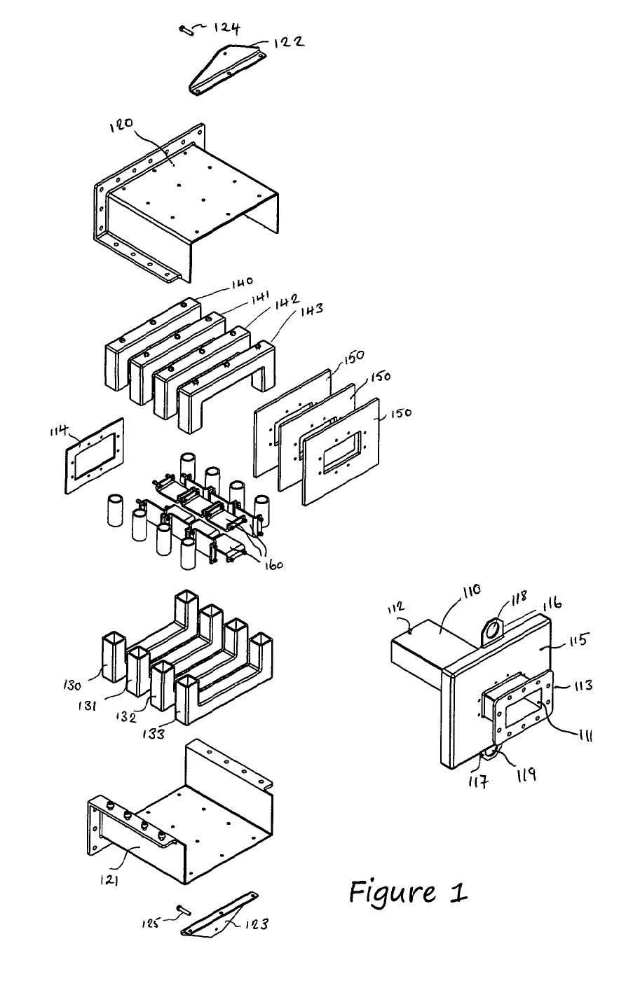

FIG. 1 is an exploded view of parts of an embodiment of a launcher in accordance with the first aspect of the invention;

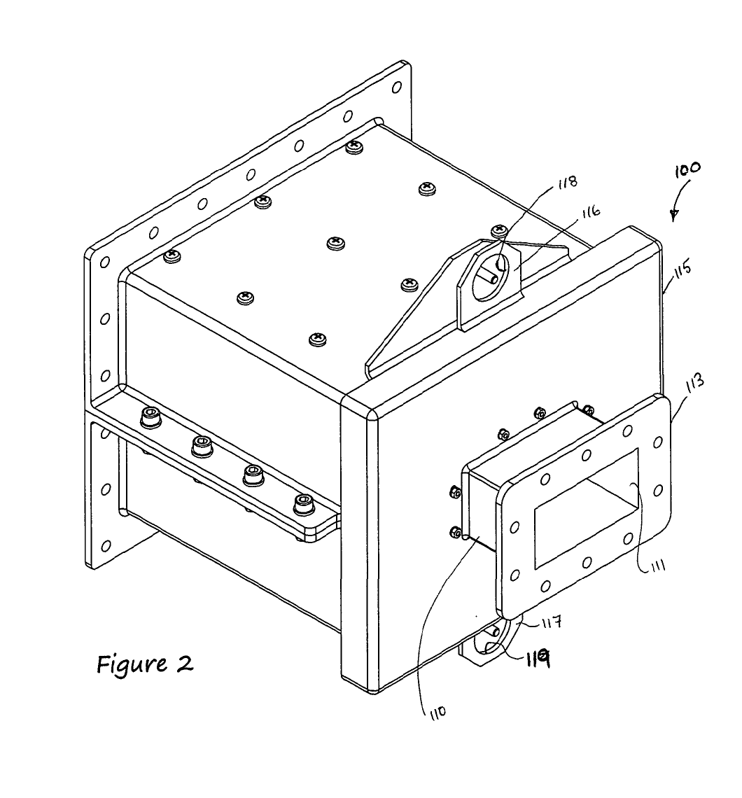

FIG. 2 is an isometric view of the launcher of FIG. 1 in an assembled state;

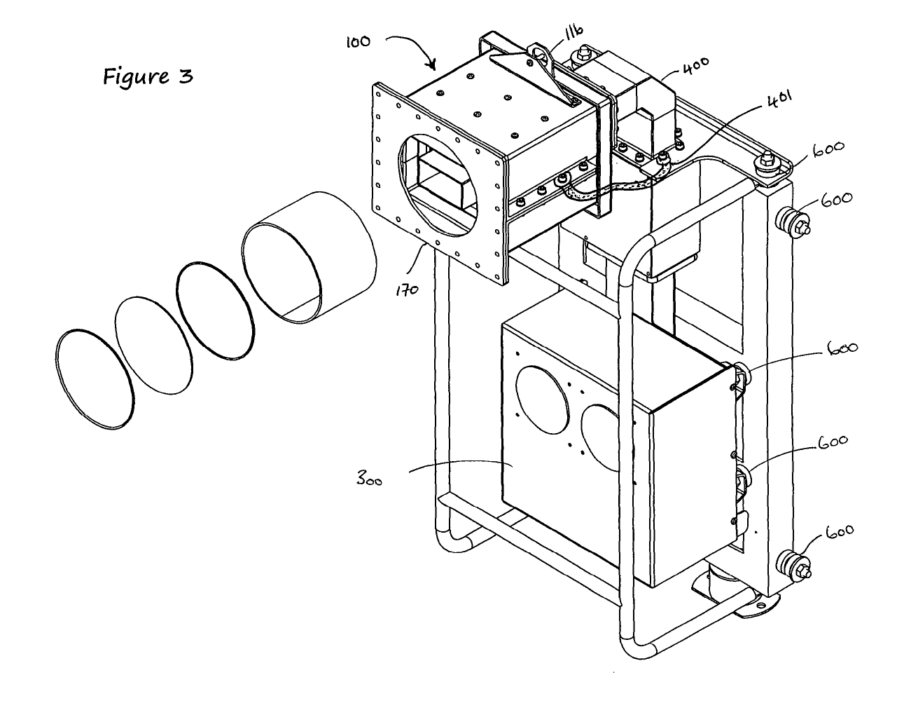

FIG. 3 is a view of the launcher of FIGS. 1 and 2 connected to a microwave source

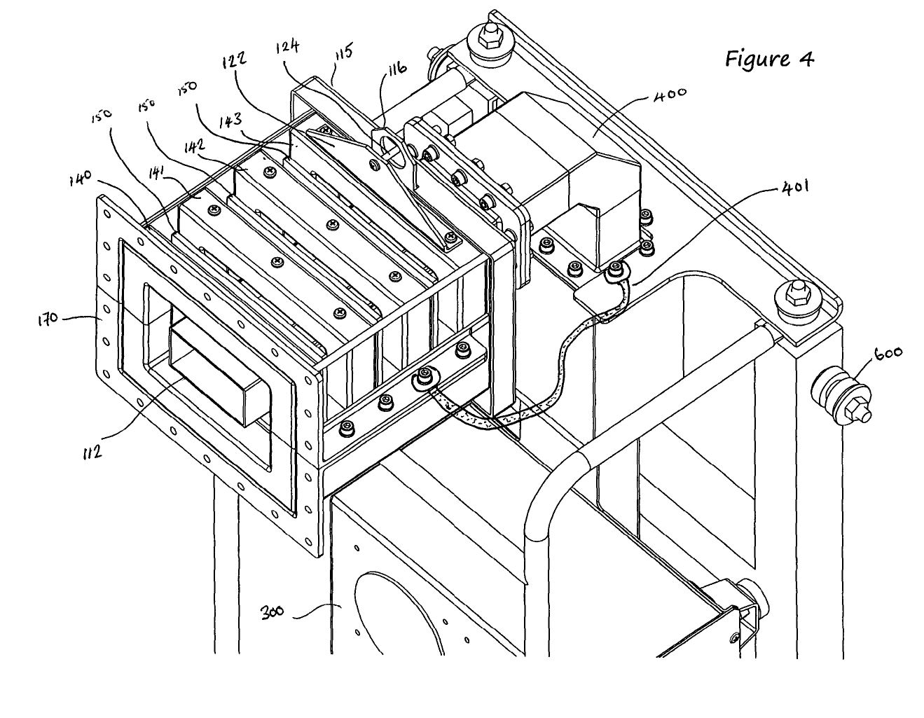

FIG. 4 is a detailed view of the launcher and source of FIG. 3 showing the relative location of the baffles inside the surround part;

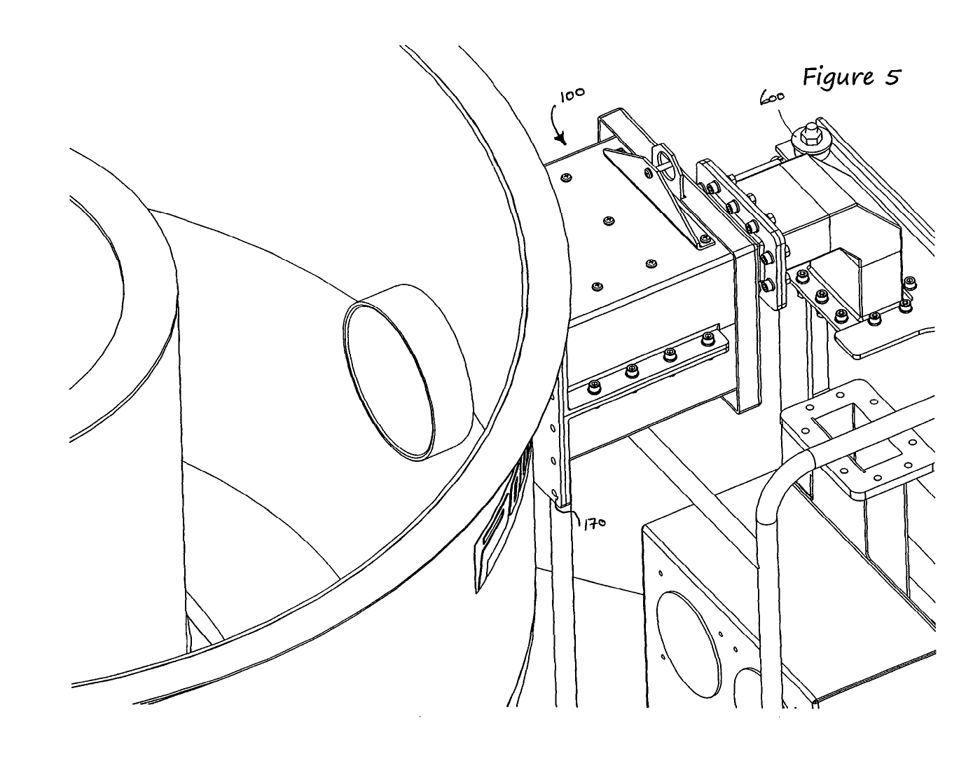

FIG. 5 is a view of the launcher connected to a container with the surround part surrounding a window through which microwaves from the guide part may pass into product contained in the container;

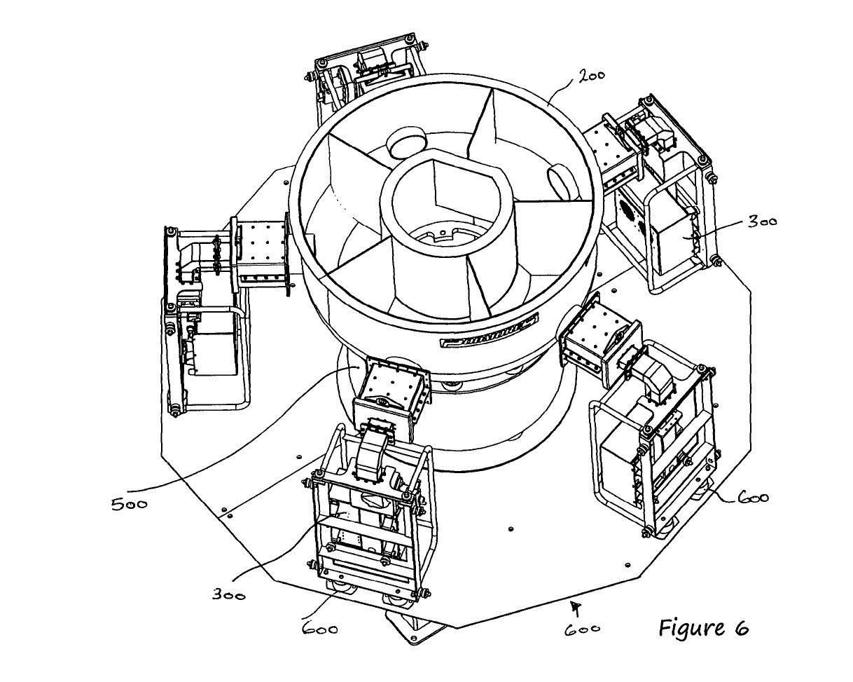

FIG. 6 is a view of five launchers arranged at spaced locations around a container;

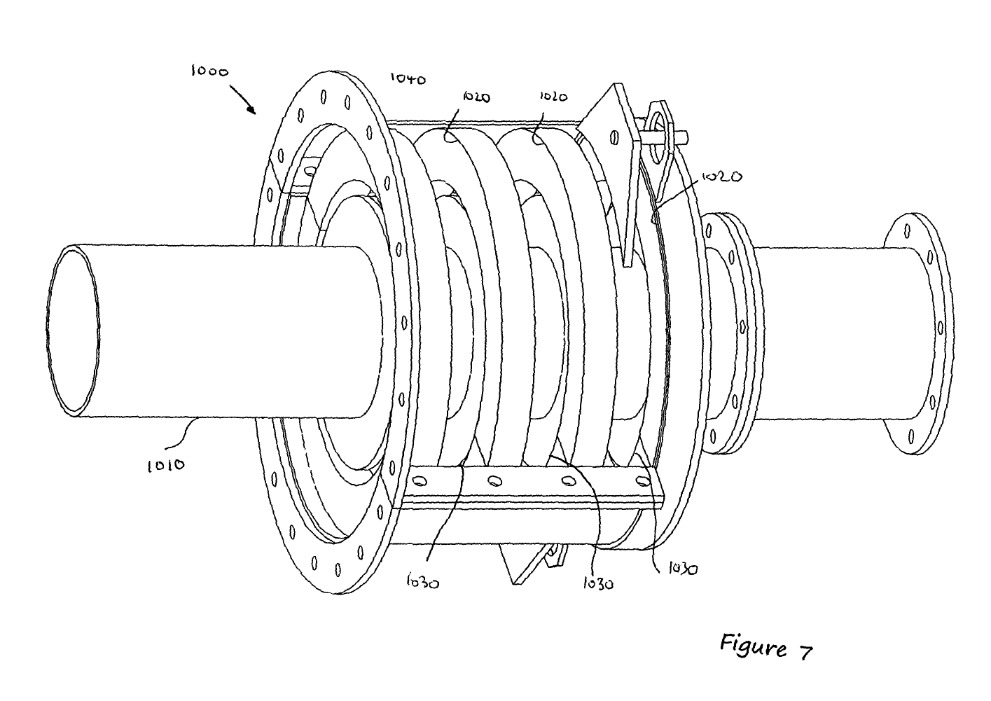

FIG. 7 is a view of an alternative embodiment of a launcher in which the guide part is circular in cross section to allow it to rotate around its long axis relative to the surround part; and

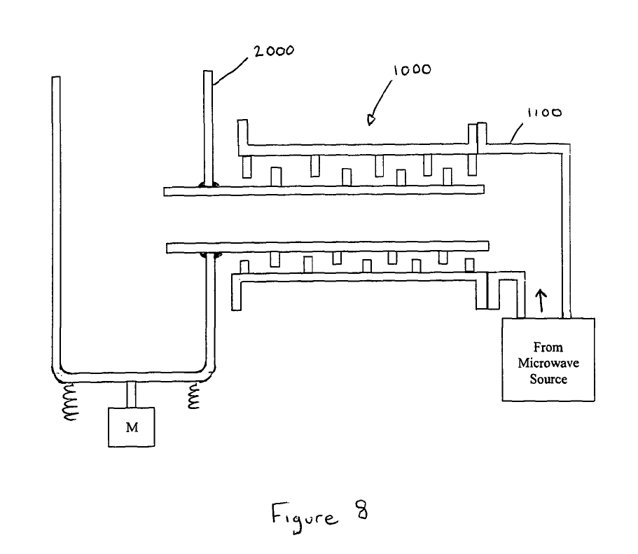

FIG. 8 is a view of the launcher of FIG. 7 connected to a container with the guide part extending into the container through a window.

An embodiment of a launcher 100 in accordance with the present invention is illustrated in exploded view in FIG. 1 and is isometric view in FIG. 2, and is shown in a position of use in FIGS. 3 and 4.

As shown in FIG. 1, the launcher 100 comprises a centrally positioned guide part 110 which comprises a waveguide of rectangular cross section. The guide part 110 has opposing first and second open ends 111,112 which are provided with respective flanges 113,114. Also secured to the guide part close to the first end 112 is a square plate 115 which extends in orthogonally outwards from the guide part 110. The plate supports one respectives one of two opposing edges an upper tab 116 and a lower tab 117. Each tab is provided with a respective circular through hole 118,119 that defines a target.

The guide part 110 is surrounded along a length between the plate 115 and the end flange 114 by a surround part. This is formed from two clam shell parts 120,121 which when secured together around the guide form a tube of rectangular cross section. The surround part 120,121 is completely spaced from the guide part, being of much larger internal dimension than the external dimensions of the guide part 110. An open end of the surround closest the plate 115 of the guide part is provided with upper and lower tabs 122,123, each of which carries a pin 124,125 that in a position of use defines a pointer which is located within a respective one of the two holes 118,119 of the tabs of the plate 115. The interaction of these pins with the holes limits the amount of movement of the surround relative to the guide part. The relative position of the pointer in the hole can be used to indicate when the surround and guide part are correctly aligned in use.

On the inside of each part of the surround 120,121 are secured four u-shaped baffle sections 130, 131,132,133 and 140,141,142, 143 with outer profiles that complement the inner surface of the surround so that there is no visible gap between each baffle and the surround. When the two parts of the surround are assembled the 4 U-shaped baffle sections on each of the halves of the surround line up to form four continuous O-shaped baffles which extend inwardly from the surround. These baffles each define a central opening through which the guide part cleanly passes. The opening is over-size so that an air gap is provided between the guide part 110 and the baffles. In use this gap allows some relative movement of the guide part 110 and surround 120 (with the baffles) without risk of contact between the guide part and the baffles.

The launcher 100 also include three outwardly facing baffles 150. Each baffle comprises a square plate with a central rectangular opening which enables it to be slotted snugly onto the guide part. Each of the plates is fixed to the guide part 110 so that there is no gap between the inner periphery of the central opening and the outside of the guide part. The plates 150 are located at axially spaced locations along the guide part so that one plate is located between each adjacent pair of the outer baffles. An axial gap is provided between each plate and any adjacent inwardly facing baffle. The precise location of the plates is set by a plurality of spacers 160 which are bolted to the guide part between the plates. The outwardly facing baffles are smaller than the inside form of the surround so that the plates do not contact the surround at any point.

The outer baffles and inner baffles 150 together define a labyrinth seal, with the only path through the surround from one end to the other being a serpentine path around the baffles with many turns. This prevents microwaves passing from one end of the surround to the other. To further prevent escape of microwaves through the labyrinth optional absorber material may be provided. As shown in FIG. 1 this may comprise a tubular insert that is located between the baffles.

The launcher may be connected to a microwave source 300 as shown in FIGS. 3 and 4, by securing the flange 113 of the guide part to a waveguide 400 secured to the source. Also shown in FIGS. 3 and 4 is a conductive bonding strap 401 comprising a braided copper wire. This connects the guide part to the surround part, and provides electromagnetic continuity. Because it is a flexible it does not create a direct rigid mechanical path between the two parts and so does not create a path of vibration to pass between the two.

In use, as shown in FIG. 5 a flange 170 provided at the end of the surround part closest the second end of the guide part 110 is secured to a wall of a container 200. The container 200 is provided with a window 210 of material which is transparent to microwaves, and which is surrounded by a sleeve that is itself located inside the flange 170 of the surround part so that the second end of the guide part 110 is located within the flange of the window. The first end of the guide part is secured to a waveguide which in turn is fixed to a source of microwaves. When secured in this way the surround is supported in such a way that it does not contact the guide part.

As shown in FIG. 6, the container 200 is supported on a bed (not shown) which is connected to a motor 500 that upon rotation causes the container to vibrate. This vibration causes the surround part to move relative to the guide part, but due to the separation between the guide part and the surround part the vibration is not passed on to the microwave source. This ensures the microwave source is protected from damage that may otherwise be caused by vibration of the container.

This figure also illustrates an arrangement in which more than one launcher is used to direct microwaves into the container from several spaced locations around the container. Each launcher 100 is connected through a waveguide to a respective magnetron 300, and the magnetrons are supported by a frame 600 which also supports the motor 500. To ensure vibration from the motor 500 is not passed through the frame to the magnetrons, vibration isolating mounts (labelled 600 in FIGS. 4 and 5) are used between the magnetron 300 and the frame 500. The outer frame part supporting the magnetrons can also be isolated from an inner part supporting the motor

The launcher should be dimensioned so that the gap between the guide part and surround part, or between the baffles, exceeds the maximum expected range of movement of the container.

Prior to switching on the motor, the relative position of the surround and guide part may be optimised by moving them until the pins sit in the centre of the holes in the tabs. With the pins in this position the spacing between the guide part and the surround part will be such that the guide part is centred with the opening in the baffles.

FIG. 7 illustrates a further embodiment of a launcher 1000 according to the present invention. This launchers is the same as that of FIG. 1 apart from the guide part 1010 being a tube of circular cross section at least where it is surrounded by the inward facing baffles 1020 which have corresponding slightly larger circular openings that the guide part passes through. The outward facing baffles 1030 also have a circular perimeter where they face the surround 1040 which is also a tube of circular cross section. With this arrangement the surround can rotate freely around the guide part, through a full 360 degrees, without any contact between the guide part of baffles attached to it and the surround or any baffles attached to it. This allows the surround 1040 to be secured to a container which is rotating, whilst still isolating the guide part 1010 from the surround.

The launcher of FIG. 1 or FIG. 7 may be connected to a static or a non-static container, with the guide part spaced apart from the container and the surround secured to the container as shown in FIGS. 3 to 6. Alternatively, the guide part may be secured to the container and the surround part secured to the source of microwaves so that it is spaced apart from the container, and the guide part, during use of the container. This is shown in FIG. 8 of the accompanying drawings for the launcher 100 of FIG. 7, with the guide part 1010 secured to a container of a centrifuge 2000 and the surround part 1020 secured through a waveguide 1100 to a microwave source 300. The guide part 1010 as shown in welded to a window in the wall of the container so that the microwave energy is directed into the container.

1. A launcher for microwave radiation comprising:
an elongate guide part having a first end for receiving microwave radiation and a second end through which the radiation may leave the guide part;
a surround part which surrounds a length of the guide part,
at least one inwardly facing baffle provided on an inner face of the surround part and extending towards the guide part; and
at least one outwardly facing baffle provided on an outer face of the guide part which is spaced axially along the guide part relative to the at least one inwardly facing baffle and faces outwards towards the inner surface of the surround part, such that the baffle(s) together with the guide part and the surround part define a labyrinth seal which in use acts as a choke to prevent microwaves from escaping the launcher by passing through the gap between the outer face of the guide part and the inner face of the surround part, and in which the launcher is so arranged that in at least one position of the surround part and the guide part there is no direct mechanical path from the surround part to the guide part, and in which the surround part and the guide part may move relative to one another in at least one direction from that position without creating a direct rigid mechanical path from the surround to the guide part.

2. A launcher according to claim 1 arranged such that there is no rigid mechanical connection between the surround part and the guide part.

3. A launcher according to claim 1 in which the surround part of the launcher or the guide part of the launcher is fixed to a container which is suitable for containing a feedstock to be heated, the container including a window, the guide part being positioned so as to pass through the window or to direct microwaves leaving the guide part through the window.

4. A launcher according to claim 1 in which the guide part comprises a waveguide of solid wall or any other suitable proprietary construction.

5. A launcher according to claim 1 in which the guide part has a rectangular or circular cross-section.

6. A launcher according to claim 1 in which the guide part is free to rotate about its long axis within the surround.

7. A launcher according to claim 1 in which the surround part is secured to a container which is in turn mounted on a vibration means which in use causes the container to vibrate.

8. A launcher according to claim 1 in which each baffle extends in a plane substantially orthogonal to the long axis of the guide part.

9. A launcher according to claim 1 in which each baffle comprises a plate with an opening through which the guide part passes.

10. A launcher according to claim 1 which includes at least 3 inwardly facing baffles and at least 2 outwardly facing baffles.

11. A launcher according to claim 1 in which absorber material is provided within the spaces between at least one pair of adjacent inwardly facing and outwardly facing baffles to help further absorb any microwaves entering the surround part.

12. A launcher according to claim 1 in which one or more of the surround part and at least one of baffles includes a fluid passage through which cooling fluid can pass to prevent excessive heating of the launcher by microwaves entering the surround part.

13. A launcher according to claim 1 in which one of the guide part and the surround part, or a part rigidly secured thereto, may be provided with a pointer, and the other part a target, the position of the pointer relative to the target providing an indication of the relative position of the guide part and the surround part.

14. A launcher according to claim 13 in which the pointer comprises a pin, and the target an opening within which the pin is located, the relative position, shape and dimensions of the pin and opening being such that the distance from the pin to the edge of the opening in any chosen direction is indicative of the smallest spacing between the guide part, or any part attached to it, and the surround part, or any part attached to it, in that same direction.

15. A combination of a launcher according to claim 1, a source of microwaves connected to the first end of the guide part of the launcher, a container secured to the second end of the surround part of the launcher, and an actuator which is connected to the container and which in use causes the container to move relative to the source of microwaves.

16. A combination of a launcher according to claim 1, a source of microwaves connected to an open end of the surround part of the launcher, a container secured to the guide part, and an actuator which is connected to the container and which in use causes the container to move relative to the source of microwaves.

17. A combination according to claim 15 in which the actuator in use causes the container to perform a vibratory movement.
